(19) United States
(12) Patent Application Publication
(10) Pub. No.: US 2005/0012932 A1
(43) Pub. Date: Jan. 20, 2005

(54) Surface plasmon resonance measuring device

(75) Inventors: Takahiro Yamada, Yamagata-shi (JP); Atushi Furusawa, Toyota-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AISIN SEIKI KABUSHIKI KAISHA, Kariya-shi (JP)

(21) Appl. No.: 10/854,182

(22) Filed: May 27, 2004

(30) Foreign Application Priority Data
May 27, 2003 (JP) 2003-149455

(51) Int. Cl. G01N 21/55

(52) U.S. Cl. 356/445

(57) ABSTRACT

A surface plasmon resonance measuring device includes a light providing means for irradiating incident light, a detecting surface at which the incident light is irradiated, a light receiving means for receiving reflected light from the detecting surface, a base plane including a pass of the incident light and a pass of the reflected light, an irradiated point at which the pass of the incident light and the pass of the reflected light are crossed, a light providing means fixing member at which the light providing means is fixed for irradiating the incident light to the irradiated point and being rotatable on an axis passing through the irradiated point and being perpendicular to the base plane, a light receiving means fixing member at which the light providing means is fixed for receiving the reflected light and being rotatable relative to the axis passing through the irradiated point and being perpendicular to the base plane, a fixing member driving mechanism for providing a drive to rotate on the base plane either one of the light providing means fixing member or the light receiving means fixing member and a link mechanism for interlocking the rotation of the light providing means fixing member and the rotation of the light receiving means fixing member.

### CROSS REFERENCE TO RELATED APPLICATIONS

This application is based on and claims priority under 35 U.S.C. § 119 to Japanese Patent Application 2003-149455, filed on May 27, 2003, the entire content of which is incorporated herein by reference.

### FIELD OF THE INVENTION

This invention generally relates to a surface plasmon resonance measuring device, more particularly, the surface plasmon resonance measuring device detects a surface plasmon resonance angle by changing the incident angle of the incident light and measuring intensity of reflected light at each incident angle.

### BACKGROUND

A device for measuring a surface plasmon resonance is disclosed in, for example, Laid-open Japanese Patent Publication No. Tokukaihei 10-239233. Such known device reflects light irradiated from a light providing means such as a leaser, and the light is reflected at an interface between a prism and a metal film and detected at a light receiving means such as a photo detector. In such device, the light providing means and the light receiving means are movable on each stage, at the same time, the light providing means moves in conjunction with the light receiving means, so that the reflected light is always irradiated into the light receiving means even if the incident angle of the incident light is changed.

According to the known surface plasmon resonance measuring device, however, the light providing means and the light receiving means are provided on the different stages respectively, so that such means need to be actuated by different plural driving mechanisms, as a result, a configuration of such device becomes complex. In addition, such device further needs a control mechanism for controlling such driving mechanisms to move being in conjunction with each other. As a result, the device becomes more complex.

This invention therefore seeks to provide a device having simple configuration, wherein the reflected light is always irradiated into the light receiving means which detects the reflected light when the intensity of the reflected light irradiated into the inputting means is measured at various incident angles.

### SUMMARY OF THE INVENTION

According to an aspect of the present invention, a surface plasmon resonance measuring device includes a light providing means for irradiating incident light, a detecting surface at which the incident light is irradiated, a light receiving means for receiving reflected light from the detecting surface, a base plane including a pass of the incident light and a pass of the reflected light, an irradiated point at which the pass of the incident light and the pass of the reflected light are crossed, a light providing means fixing member at which the light providing means is fixed for irradiating the incident light to the irradiated point and being rotatable on an axis passing through the irradiated point and being perpendicular to the base plane, a light receiving means fixing member at which the light providing means is fixed for receiving the reflected light and being rotatable relative to the axis passing through the irradiated point and being perpendicular to the base plane, a fixing member driving mechanism for providing a drive to rotate on the base plane either one of the light providing means fixing member or the light receiving means fixing member and a link mechanism for interlocking the rotation of the light providing means fixing member and the rotation of the light receiving means fixing member.

According to another aspect of the present invention, a surface plasmon resonance measuring device includes a sensor chip including a transparent board and a metal film provided on a first main surface of the transparent board to be contacted with a sample at the metal film side thereof, a prism provided at a second main surface of the sensor chip opposite to the metal film side, a light providing means for irradiating an incident light through the prism to a detecting surface formed on one surface of the metal film opposite to the transparent board side, a light receiving means for detecting a reflected light from the detecting surface, a flow pass plate at which a sample flowing pass where the sample flows is formed for contacting the sample to the metal film, a light shielding means for shielding all lights irradiated to the transparent board except the incident light, a base plane including a pass of the incident light and a pass of the reflected light, an irradiated point at which the pass of the incident light and the pass of the reflected light are crossed, a light providing means fixing member at which the light providing means is fixed for irradiating the incident light to the irradiated point and being rotatable on an axis passing through the irradiated point and being perpendicular to the base plane, a light receiving means fixing member at which the light providing means is fixed for receiving the reflected light and being rotatable relative to the axis passing through the irradiated point and being perpendicular to the base plane, a fixing member driving mechanism for providing a drive to rotate on the base plane either one of the light providing means fixing member or the light receiving means fixing member and a link mechanism for interlocking the rotation of the light providing means fixing member and the rotation of the light receiving means fixing member.

### BRIEF DESCRIPTION OF THE DRAWINGS

The foregoing and additional features and characteristics of the present invention will become more apparent from the following detailed description considered with reference to the accompanying drawings, wherein:

FIG. 1 illustrates a schematic view of a surface plasmon resonance measuring device related to the current invention;

FIG. 2 illustrates a cross section view of the surface plasmon resonance measuring device along a line A-A in FIG. 1;

FIG. 3 illustrates a projected drawing of the surface plasmon resonance measuring device downwardly projected from a cross section along a line B-B in FIG. 1;

FIG. 4 illustrates a drawing explaining a link mechanism of the surface plasmon resonance measuring device related to the current invention in detail;

FIG. 5 illustrates an enlarged drawing of a part of an attached structure of the link mechanism shown in FIG. 3, and

FIG. 6 illustrates an enlarged drawing of another part of the attached structure of the link mechanism shown in FIG. 3.

### DETAILED DESCRIPTION

Preferred embodiments of the current invention will be described hereinbelow in detail with reference to the accompanying drawings. A surface plasmon resonance measuring device related to the current invention can be a optical bio sensor device for measuring concentration of a sample using biomolecule such as an antigen or an antibody.

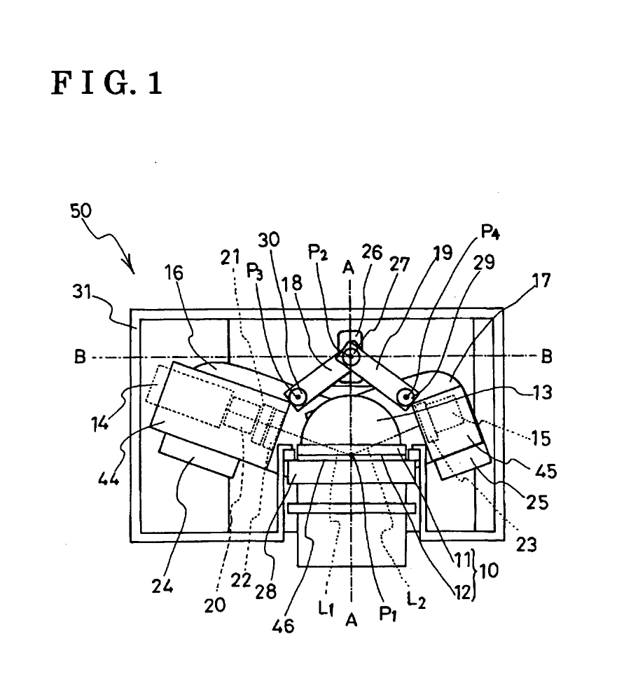

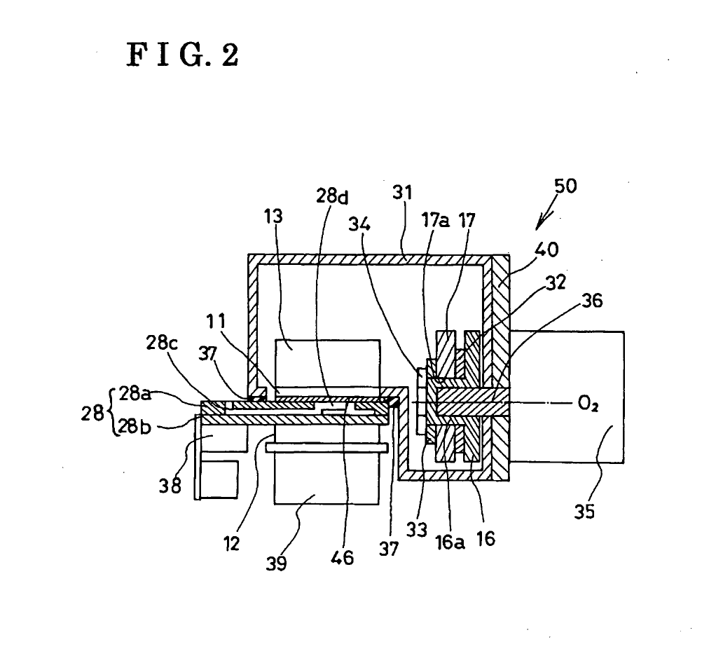

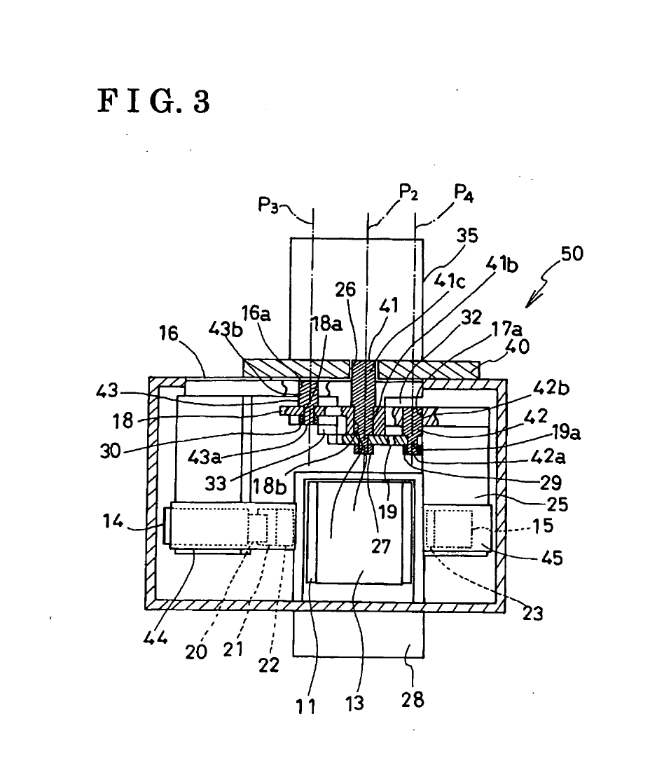

FIG. 1 illustrate a schematic view of a surface plasmon resonance measuring device 50 (hereinbelow referred to as SPR device 50) related to the embodiment. FIG. 2 illustrates a cross section view of the surface plasmon resonance measuring device along a line A-A in FIG. 1. To make the drawing more recognizable, only portions considered to be important for explaining the mechanism of the device are hatched. FIG. 3 illustrates a projected drawing of the surface plasmon resonance measuring device downwardly projected from a cross section along a line B-B in FIG. 1. In this drawing, portions considered to be important for explaining the mechanism of the SPR device 50 (portions related to the link mechanism) are illustrated as a cross sectional diagram.

As shown in FIG. 1, the SPR device 50 according to the embodiment includes a sensor chip 10 having a glass board 11 as a transparent board and an Au film 12 as a metal film provided on a first main surface of the glass board 11, a flow pass plate 28 through which the sample flows to be contacted to the sensor chip 10 at the Au film 12 side thereof, a prism 13 having a same refractive index as the glass board 11 has and provided on a second main surface of the glass board 11 opposite to the first main surface where the Au film 12 is provided, a light emitting element 14 (hereinbelow referred to as LD 14) as a light providing means and a photo detector 15 (hereinbelow referred to as PD 15) as a light receiving means. Incident light is irradiated from the LD 14 as a measuring light through the prism 13 to the glass board 11 at the Au film 12 side thereof, the incident light is reflected at an interface between the glass board 11 and the Au film 12, then the reflected light is detected at the PD 15. The sample for measurement is contacted to a surface of the Au film 12 at which the glass board 11 is not provided. Hereinafter, such surface of the Au film 12 at which the glass board 11 is not provided is referred to as a surface plasmon detecting surface (SP detecting surface 46). L1 illustrated in FIG. 1 shows a path of the incident light, and L2 illustrated in FIG. 1 shows a path of the reflected light The incident light is irradiated through the pass L1 and reflected near the interface between the glass board 11 and the Au film 12. The reflected light is irradiated through the pass L2 to the receiving surface of the PD 15. The light from the outside of the device is shut out by a cover 31 as a shielding means, so that only the incident light can be irradiated into the sensor chip 10.

When the incident light is irradiated from the LD 14 to be totally reflected at the interface between the glass board 11 and the Au film 12 of the sensor chip 10, an energy wave called an evanescent wave is generated at the Au film 12 side. The energy of the evanescent wave is used to resonate the plasmon, so that the energy of the evanescent is decreased at specific incident angles of the incident light. Specifically, it is confirmed that the intention of the reflected light at the specific angles is degraded. Such optical phenomenon is called SPR (surface plasmon resonance).

An angle at which the reflected light is faded away differs depending on a refractive index of the sample near the surface of the SP detecting surface 46. Using this phenomenon, the SPR device 50 measures bond and dissociation of two molecules. Specifically, the antibody is fixed to a self-assembled layer formed at the SP detecting surface 46, and a sample including antigen TG being recognized by the specific antibody flows through the sample following pass 28c of the flow pass plate 28 within an area where the antibody is fixed to the SP detecting surface 46. When the antibody specifically reacts with the antigen, the mass of the surface of the sensor chip 10 is increased, as a result, the refractive index of the surface of the sensor chip 10 is increased. In response to the change of the refractive index, the incident angle of the incident light will be changed. Bond of two molecules at the surface of the sensor chip 10 can be monitored in real time by displaying variation per hour of the incident light in a graph called a sensorgram.

The LD 14 is fixed to a LD fixing board 16 as a fixing member of the light providing means, so that the inputting light from the LD 14 is irradiated near the Au film 12 of the sensor chip 10. The PD 15 is fixed to a PD fixing board 17 as a fixing member of the light receiving means, so that the light receiving surface of the PD 15 faces an irradiated point P1 of the SP detecting surface 46 for detecting the reflected light from the SP detecting surface 46. As shown in FIG. 1 and FIG. 3, a LD supporting base 24 is fixed at the LD fixing board. Furthermore, a LD housing case 44 is fixed at the LD supporting base 24. The LD housing case 44 houses the LD 14, a splitter 20, a deflecting plate 21 and a pinhole 22. The LD 14, the splitter 20, the deflecting plate 21 and the pinhole 22 are positioned and fixed at the LD housing case 44. On the other hand, a PD supporting base 25 is fixed at the PD fixing board 17. Furthermore, a PD housing case 45 is fixed at the PD supporting base 25. The PD housing case 45 houses the PD 15 and a pinhole 23. The PD 15 and the pinhole 23 are positioned and fixed at the PD housing case 45.

One end of a first link member 18 is attached to the LD fixing board 16 by a supporting member 30 at a first supporting point P3, so that the first link member 18 is rotatable relative to the first supporting point 3. On the other hand, one end of a second link member 19 is attached to the PD fixing board 17 by a supporting member 29 at a second supporting point P4, so that the second link member 19 is rotatable relative to the second supporting point P4. In addition, a supporting member 27 interconnects the other end of the first link member 18 and the other end of the second link member 19 at a supporting point P2, so that the first link member 18 and the second link member 19 can relatively rotate relative to the supporting point P2. In this way, the first link member 18, the second link member 19, the supporting members 27, 29, and 30 configures the link mechanism related to the current invention.

As shown in FIG. 2, the SPR device 50 of the embodiment includes a motor 35 as a driving mechanism for rotating either one of the LD fixing board 16 or the PD fixing board 17 relative to the irradiated point P1. The motor 35 includes a motor shaft 36 whose axis O2 thereof is positioned in the same plane with the interface between the glass board 11 and the Au film 12, and the axis O2 passes through the irradiated point P1 illustrated in FIG. 1. Furthermore, the motor shaft 36 is fixed to the LD fixing board 16, so that the motor 35 in this embodiment drives the LD fixing board 16 rotatably relative to the irradiated point P1 in FIG. 1. Specifically, the motor shaft 36 is covered by a cylinder portion 16a formed at the LD fixing board 16, and the LD fixing board 16 is fixed to the motor shaft 36 by a fixing member 34 attached from a bottom portion of the cylinder portion 16a The cylinder portion 16a of the LD fixing board 16 is inserted into a hole 17a formed at the PD fixing board 17, so that the PD fixing board 17 is positioned relative to the LD fixing board 16. A thrust bearing 32 is provided between the LD fixing board 16 and the PD fixing board 17, and a thrust bearing 33 is provided between the PD fixing board 17 and the fixing member 34. The PD fixing board 17 is independent from the LD fixing board 16 to be rotatably relative to the irradiated point P1 in FIG. 1 (relative to the axis O2 of the motor shaft 36).

As shown in FIG. 2, a sample flowing pass 28c is formed at the flow pass plate 28. A part of the sample flowing pass 28c is formed to be exposed toward the Au film 12 side. Thus, a sample melted into solvent flows through the sample flowing pass 28c and contacts with the Au film 12, as a result, the surface plasmon resonant measurement relative to the sample can be performed. Specifically, the flow pass plate 28 includes an upper plate 28a and a lower plate 28b, and a part of the sample flowing pass 28c is formed by a groove portion of the upper plate 28a over which the lower plate 28b is covered.

The antigen to be combined with a certain antibody is provided at the sample supporting portion 28d being exposed to the Au film 12. Specifically, the antibody is fixed to the surface of the Au film 12 of the sensor chip 10 which is exposed to the sample supporting portion 28d, and the antigen in the solvent flowing through the sample flowing pass 28c is to be combined with the antibody by means of a specific antibody-antigen response. Thus, an interaction of molecules can be monitored in real time by measuring the surface plasmon resonance by irradiating the incident light to the surface of the sensor chip 10 at which the sample supporting portion 28d is formed.

A temperature adjustment apparatus 39 for adjusting the temperature of the sample is provided right below the flow pass plate 28, and the temperature adjustment apparatus 39 contacts with thee flow pass plate 28.

In addition, the flow pass plate 28 includes a valve mechanism 38 for opening and closing the sample flowing pass 28c to control the flow of the sample through the sample flowing pass 28c. The valve mechanism 38 controls the sample to flow through the sample flowing pass 28c or to stop the flow of the sample through the sample flowing pass 28c. Plural sample flowing passes 28c can be formed at the flow pass plate 28, so that the valve mechanism 38 controls the plural sample flowing passes to be opened or closed.

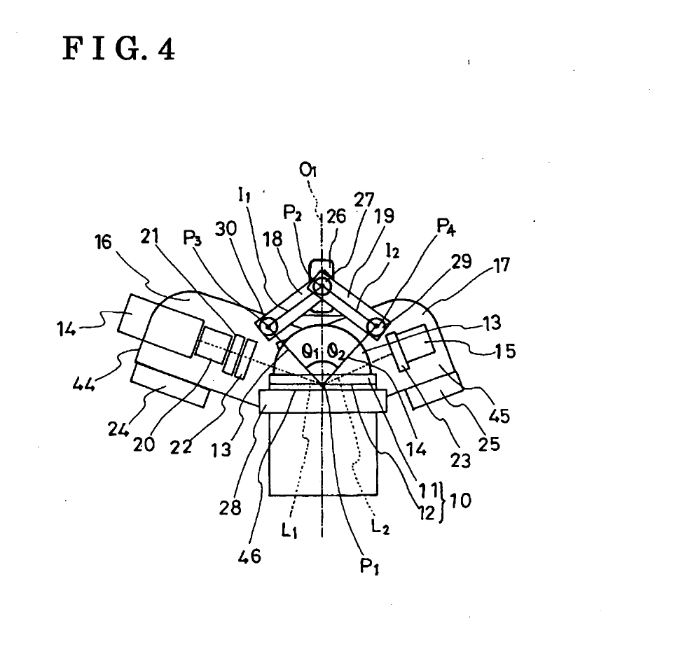

The link mechanism according to this embodiment is explained in detail referring to FIG. 4. In FIG. 4, some members of the device which is not necessary for explaining the configuration of the device is not shown in this drawing. The link mechanism of this embodiment includes the supporting point P2, the first supporting point P3 and the second supporting point P4, wherein each distance between the supporting point P2 and the first supporting point P3 is identical to the distance between the supporting point P2 and the second supporting point P4 are the same on a base plane (in FIG. 4) which is including the pass L1 of the incident light and the pass L2 of the reflected light. Specifically, in FIG. 4, a line segment S1 connecting the supporting point P2 and the first supporting point P3 is identical to a line segment S2 connecting the supporting point P2 and the second supporting point P4. In addition, the distance between the irradiated point P1 and the first supporting point P3 on the base plane is identical to the distance between the irradiated point P1 and the second supporting point P4. Specifically, in FIG. 4, a line segment S3 connecting the irradiated point P1 and the first supporting point P3 is identical to a line segment S4 connecting the irradiated point P1 and the second supporting point P4.

On the base plane including the pass L1 of the incident light and the pass L2 of the reflected light, the supporting point P2 is positioned on a plan including a center line O1 passing through the irradiated point P1 and being perpendicular relative to the SP detecting surface 46, and the enter point O2 of the motor shaft 36. The supporting member 27 for connecting the first link member 18 and the second link member 19 is movable in vertical direction in FIG. 4 allowing the supporting point P2 move along the center line O1.

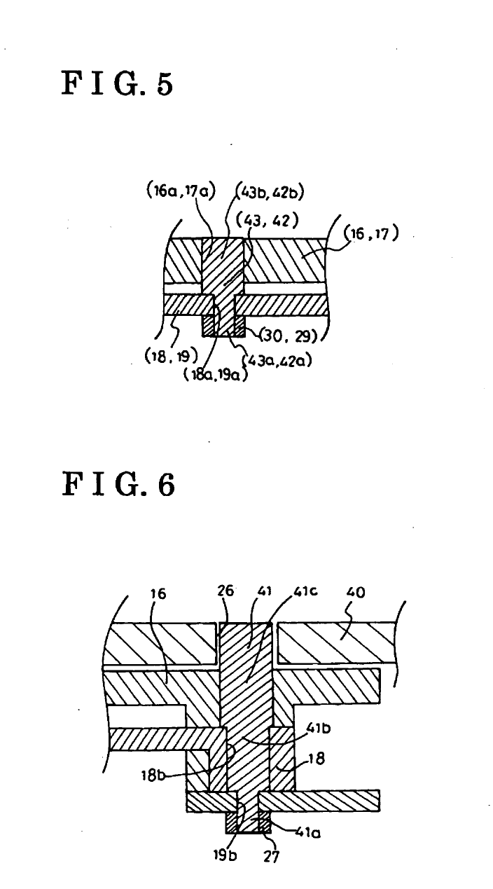

An assembling structure of the link mechanism according to this embodiment is explained referring to FIGS. 3, 4 and 5. FIG. 3 indicates a whole image of the assembling structure, FIG. 5 indicates in detail an assembling structure of the LD fixing member 16 and the first link mechanism 18, and an assembling structure of the PD fixing member 17 and the second link mechanism 19. FIG. 6 indicates in detail an assembling structure of the first link member 18 and the second link member 19.

As shown in FIG. 3 and FIG. 5, the LD fixing member 16 includes a cylindrical opening 16a whose center is positioned at the first supporting point P3, on the other hand, the first link member 18 includes a cylindrical opening 18a whose center is positioned at the first supporting point P3. A supporting pin 43 is penetrated into the opening 16a and 18a. The supporting pin 43 includes a first cylindrical portion 43a having an outer diameter corresponding to an inner diameter of the opening 18a of the first link member 18, and a second cylindrical portion 43b having an outer diameter corresponding to an inner diameter of the opening 16a of the LD fixing board 16. The first cylindrical portion 43a is penetrated into the opening 18a of the first link member 18, and the second cylindrical portion 43b is penetrated into the opening 16a of the LD fixing board 16. A top portion of the supporting pin 43 is projected from the surface of the first link member 18, and the supporting member 30 is attached to such projecting portion of the supporting pin 43. Thus the LD fixing board 16 is connected to the first link member 18 rotatably relative to the first supporting point P3.

Furthermore, the PD fixing board 17 includes a cylindrical opening 17a whose center is the second supporting point P4, and the second link member 19 includes a cylindrical opening 19a whose center is the second supporting point P4. A supporting pin 42 is penetrated into the opening 17a and the opening 19a. The supporting pin 42 includes a first cylindrical portion 42a having an outer diameter corresponding to a inner diameter of the opening 19a of the second link member 19, and a second cylindrical portion 42b having an outer diameter corresponding to a inner diameter of the opening 17a of the PD fixing board 17. The first cylindrical portion 42a is penetrated into the opening 19a of the second link member 19, and the second cylindrical portion 42b is penetrated into the opening 17a of the PD fixing board 17. A top portion of the supporting pin 42 is projected from the surface of the second link member 19, and the supporting member 29 is attached to such projecting portion of the supporting pin 42. Thus the PD fixing board 17 is connected to the second link member 19 rotatably relative to the second supporting point P4.

Furthermore, as shown in FIG. 3 and FIG. 6, the first link member 18 includes a cylindrical opening 18b whose center is the supporting point P2, and the second link member 19 includes a cylindrical opening 19b whose center is the supporting point P2. A supporting pin 41 is penetrated into the opening 18b and the opening 19b. The supporting pin 41 includes a first cylindrical portion 41a having an outer diameter corresponding to an inner diameter of the opening 19b of the second link member 19, and a second cylindrical portion 41b having an outer diameter corresponding to a inner diameter of the opening 18b of the first link member 18. The first cylindrical portion 41a is penetrated into the opening 19b of the second link member 19, and the second cylindrical portion 41b is penetrated into the opening 18b of the first link member 18. A top portion of the supporting pin 41 is projected from the surface of the second link member 19, and the supporting member 27 is attached to such projecting portion of the supporting pin 41. Thus the first link member 18 is connected to the second link member 19 rotatably relative to the supporting point P2.

Furthermore, the supporting pin 41 includes a third cylindrical portion 41c being larger than the first cylindrical portion 41a and the second cylindrical portion 41b. Specifically, an outer diameter of the third cylindrical portion 41c is larger than the outer diameter of the second cylindrical portion 41b, and the second cylindrical portion 41b is larger than the outer diameter of the first cylindrical portion 41a. One end of the third cylindrical portion 41c is penetrated into an opening 26 formed at a fixing board 40 which is provided along the side of the SPR device 50. As shown in FIG. 1 and FIG. 6, a width of the opening 26 is slightly larger than the outer diameter of the third cylindrical portion 41c of the supporting pin 41, and the opening 26 extends in vertical direction as shown in FIG. 1. Thus, the supporting pin 41 penetrating into the opening 26 is movable in vertical direction in FIG. 1, as a result, the end portions of the first link member 18 and the second link member 19 are also movable in vertical direction in FIG. 1.

An operation of the aforementioned link mechanism is explained as follows. First, the LD fixing board 16 is rotated relative to the irradiated point P1 by the drive from the motor 35, then the first link member 18 fixed to the LD fixing board 16 is rotated relative to the first supporting point P3 as shown in FIG. 4, as a result, the supporting point P2 of the first link member 18 is moved in vertical direction in FIG. 1. Then the end portion of the second link member 19 to which the end portion of the first link member 18 is connected at the supporting point P2 moves in vertical direction in FIG. 1. Thus, the other end portion of the second link member 19 being the second supporting point P4 side is moved along an arc relative to the irradiated point P1, as a result, the PD fixing board 17 fixed to the second link member 19 at the second supporting point P4 is rotated relative to the irradiated point P1. In such configuration, the line segment S1 between the supporting point P2 and the first supporting point P3 is identical to the line segment S2 between the supporting point P2 and the second supporting point P4, and the line segment S3 between the irradiated point P1 and the first supporting point P3 is identical to the line segment S4 between the irradiated point P1 and the second supporting point P4. This means that an angle è1 between the center line O1 and the line segment S3 is identical to an angle è2 between the center line O1 and the line segment S4. The supporting point P2 is moved only on the center line O1, so that the angle è1 is always identical to the angle è2. Furthermore, the LD 14 is fixed to the LD fixing board 16, and the PD 15 is fixed to the PD fixing board 17, so that the PD 15 always detects the reflected light even if the incident angle of the incident light is changed by rotating the LD fixing board relative to the irradiated point P1.

In the SPR device 50 according to this embodiment, the angle of the pass L1 of the incident light can be changed by rotating the LD fixing board by the drive from the single motor 35 relative to the irradiated point P1. In addition, the link mechanism of the SPR device enables the PD fixing board 17 to be rotated relative to the irradiated point P1 corresponding to the angle change of the pass L1 of the incident light. In this way, there is no need to use plural motor to rotate the PD 15 as a light receiving means for detecting the reflected light if the pass L is changed, as a result, the device becomes simpler and smaller, and the cost of the device can be reduced.

The application of the current invention is not limited to the aforementioned embodiment For example, the LD fixing board 16 is rotated by the drive from the motor 35, and the PD fixing board 17 is rotated by the link mechanism in conjunction with the rotation of the LD fixing board 16 in the embodiment. The motor shaft 36 of the motor 35, however, may be attached to the PD fixing board 17 for rotating the PD fixing board 17. In this case, when the PD fixing board 17 is rotated relative to the irradiated point P1 by the drive from the motor 35, the link mechanism enables the LD fixing board 16 to rotate relative to the irradiated point P1 in conjunction with the rotating of the PD fixing board 17, as a result, the angle of the pass L1 of the incident light can be changed. In such mechanism, there is no need to use plural motors as driving mechanisms to rotate the PD fixing board 17.

Furthermore, such driving mechanism for rotating the LD fixing board 16 or the PD fixing board 17 may be an actuator, such as a linear actuator for moving the supporting point P2 in vertical direction in FIG. 1.

The principles, preferred embodiment and mode of operation of the current invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the current invention. Accordingly, it is expressly intended that all such variations, changes and equivalents which fall within the spirit and scope of the current invention as defined in the claims, be embraced thereby.

1. A surface plasmon resonance measuring device comprising:
a light providing means for irradiating incident light;
a detecting surface at which the incident light is irradiated;
a light receiving means for receiving reflected light from the detecting surface;
a base plane including a pass of the incident light and a pass of the reflected light;
an irradiated point at which the pass of the incident light and the pass of the reflected light are crossed;
a light providing means fixing member at which the light providing means is fixed for irradiating the incident light to the irradiated point and being rotatable on an axis passing through the irradiated point and being perpendicular to the base plane;
a light receiving means fixing member at which the light providing means is fixed for receiving the reflected light and being rotatable relative to the axis passing through the irradiated point and being perpendicular to the base plane;
a fixing member driving mechanism for providing a drive to rotate on the base plane either one of the light providing means fixing member or the light receiving means fixing member and
a link mechanism for interlocking the rotation of the light providing means fixing member and the rotation of the light receiving means fixing member.

2. A surface plasmon resonance measuring device comprising:
a sensor chip including a transparent board and a metal film provided on a first main surface of the transparent board to be contacted with a sample at the metal film side thereof;
a prism provided at a second main surface of the sensor chip opposite to the metal film side;
a light providing means for irradiating an incident light through the prism to a detecting surface formed on one surface of the metal film opposite to the transparent board side;
a light receiving means for detecting a reflected light from the detecting surface;
a flow pass plate at which a sample flowing pass where the sample flows is formed for contacting the sample to the metal film;
a light shielding means for shielding all lights irradiated to the transparent board except the incident light;
a base plane including a pass of the incident light and a pass of the reflected light;
an irradiated point at which the pass of the incident light and the pass of the reflected light are crossed;
a light providing means fixing member at which the light providing means is fixed for irradiating the incident light to the irradiated point and being rotatable on an axis passing through the irradiated point and being perpendicular to the base plane;
a light receiving means fixing member at which the light providing means is fixed for receiving the reflected light and being rotatable relative to the axis passing through the irradiated point and being perpendicular to the base plane;
a fixing member driving mechanism for providing a drive to rotate on the base plane either one of the light providing means fixing member or the light receiving means fixing member and
a link mechanism for interlocking the rotation of the light providing means fixing member and the rotation of the light receiving means fixing member.

3. A surface plasmon resonance measuring device according to claim 2, wherein a temperature adjusting device is provided for adjusting a temperature of the sample in the sample flowing pass through the flow pass plate.

4. A surface plasmon resonance measuring device according to claim 1, wherein the link mechanism includes a first link member attached at one end thereof to a first supporting point provided at the light providing means fixing member rotatably on the base plane and a second link member attached at one end thereof to a second supporting point provided at the light receiving means fixing member rotatably on the base plane, the first link member and the second link member are connected rotatably relative to a supporting point at the other ends thereof, the supporting point is movable along a center line being vertical to the detecting surface and passing through the irradiated point on the base plane, a distance between the supporting point and the first supporting point on the base plane is identical to a distance between the supporting point and the second supporting point on the base plane, and a distance between the irradiated point and the first supporting point on the base plane is identical to a distance between the irradiated point and the second supporting point on the base plane.

5. A surface plasmon resonance measuring device according to claim 2, wherein the link mechanism includes a first link member attached at one end thereof to a first supporting point provided at the light providing means fixing member rotatably on the base plane and a second link member attached at one end thereof to a second supporting point provided at the light receiving means fixing member rotatably on the base plane, the first link member and the second link member are connected rotatably relative to a supporting point at the other ends thereof, the supporting point is movable along a center line being vertical to the detecting surface and passing through the irradiated point on the base plane, a distance between the supporting point and the first supporting point on the base plane is identical to a distance between the supporting point and the second supporting point on the base plane, and a distance between the irradiated point and the first supporting point on the base plane is identical to a distance between the irradiated point and the second supporting point on the base plane.

6. A surface plasmon resonance measuring device according to claim 3, wherein the link mechanism includes a first link member attached at one end thereof to a first supporting point provided at the light providing means fixing member rotatably on the base plane and a second link member attached at one end thereof to a second supporting point provided at the light receiving means fixing member rotatably on the base plane, the first link member and the second link member are connected rotatably relative to a supporting point at the other ends thereof, the supporting point is movable along a center line being vertical to the detecting surface and passing through the irradiated point on the base plane, a distance between the supporting point and the first supporting point on the base plane is identical to a distance between the supporting point and the second supporting point on the base plane, and a distance between the irradiated point and the first supporting point on the base plane is identical to a distance between the irradiated point and the second supporting point on the base plane.

7. A surface plasmon resonance measuring device according to claim 1, wherein the fixing member driving mechanism is a motor including a motor shaft whose axis is perpendicular to the base plane and passing through the irradiated point, and fixed to either one of the light providing means fixing member or the light receiving means fixing member.

8. A surface plasmon resonance measuring device according to claim 2, wherein the fixing member driving mechanism is a motor including a motor shaft whose axis is perpendicular to the base plane and passing through the irradiated point, and fixed to either one of the light providing means fixing member or the light receiving means fixing member.

9. A surface plasmon resonance measuring device according to claim 3, wherein the fixing member driving mechanism is a motor including a motor shaft whose axis is perpendicular to the base plane and passing through the irradiated point, and fixed to either one of the light providing means fixing member or the light receiving means fixing member.

10. A surface plasmon resonance measuring device according to claim 4, wherein the fixing member driving mechanism is a motor including a motor shaft whose axis is perpendicular to the base plane and passing through the irradiated point, and fixed to either one of the light providing means fixing member or the light receiving means fixing member.

11. A surface plasmon resonance measuring device comprising:
a light providing means for irradiating incident light to a detecting surface; a light receiving means for receiving reflected light from the detecting surface;
a light providing means fixing member for fixing the light providing means, the light providing means fixing member being rotatable relative to an axis, which passes through an irradiated point on the detecting surface and being perpendicular to a base plane including a pass of the incident light and a pass of the reflected light;
a receiving means fixing member for fixing the receiving means, the receiving means fixing member being rotatable relative to the axis;
a fixing member driving mechanism for driving either one of the light providing means fixing member and the light receiving means fixing member; and
a link mechanism for interlocking the rotation of the light providing means fixing member and the light receiving means fixing member.
